(19) United States
(12) Patent Application Publication
(10) Pub. No.: US 2012/0288636 A1
(43) Pub. Date: Nov. 15, 2012

(54) TEMPLATE FOR IMPRINTING AND IMPRINTING METHOD

(76) Inventor: Hiroshi TOKUE, Yokohama-shi (JP)

(21) Appl. No.: 13/368,220

(22) Filed: Feb. 7, 2012

(30) Foreign Application Priority Data
May 11, 2011 (JP) 2011-106410

(51) Int. Cl. C08J 7/04; B29C 59/16

(52) U.S. Cl. 427/510; 118/44

(57) ABSTRACT

According to one embodiment, a template for imprinting includes a concave-convex pattern on one surface thereof. The template includes a base material having light transmission characteristics, and a resin layer provided on the base material and becoming convex portions of the concave-convex pattern. The resin layer contracts and reduces its volume by irradiation of light having a first wavelength and expands and increases its volume by irradiation of light having a second wavelength, which is different from the first wavelength.

### CROSS REFERENCE TO RELATED APPLICATION

This application is based upon and claims benefit of priority from the Japanese Patent Application No. 2011-106410, filed on May 11, 2011, the entire contents of which are incorporated herein by reference.

### FIELD

Embodiments described herein relate generally to a template for imprinting and an imprinting method.

### BACKGROUND

As a technique to form a fine pattern at low cost, an optical nanoimprinting method is known. This is a method in which a template having concave-convex portions corresponding to a pattern that is desired to be formed on a substrate is pressed on a light curable organic material layer applied on a surface of the substrate, is irradiated with light to harden the organic material layer, and is demolded from the organic material layer, to transfer the pattern.

However, in the process of demolding the template from the organic material layer, there is a problem in which a frictional force is applied to the organic material layer contacting a sidewall of the concave-convex pattern of the template to cause the pattern on the organic material layer to be damaged.

### BRIEF DESCRIPTION OF THE DRAWINGS

FIG. 1 is a vertical cross-sectional view of a template for imprinting according to an embodiment of the present invention;

FIGS. 2A to 2C are process cross-sectional views illustrating an imprinting method according to the embodiment; and

FIGS. 3A to 3C are process cross-sectional views illustrating an imprinting method according to the embodiment.

### DETAILED DESCRIPTION

According to one embodiment, a template for imprinting includes a concave-convex pattern on one surface thereof. The template includes a base material having light transmission characteristics, and a resin layer provided on the base material and becoming convex portions of the concave-convex pattern. The resin layer contracts and reduces its volume by irradiation of light having a first wavelength and expands and increases its volume by irradiation of light having a second wavelength, which is different from the first wavelength.

Embodiments will now be explained with reference to the accompanying drawings.

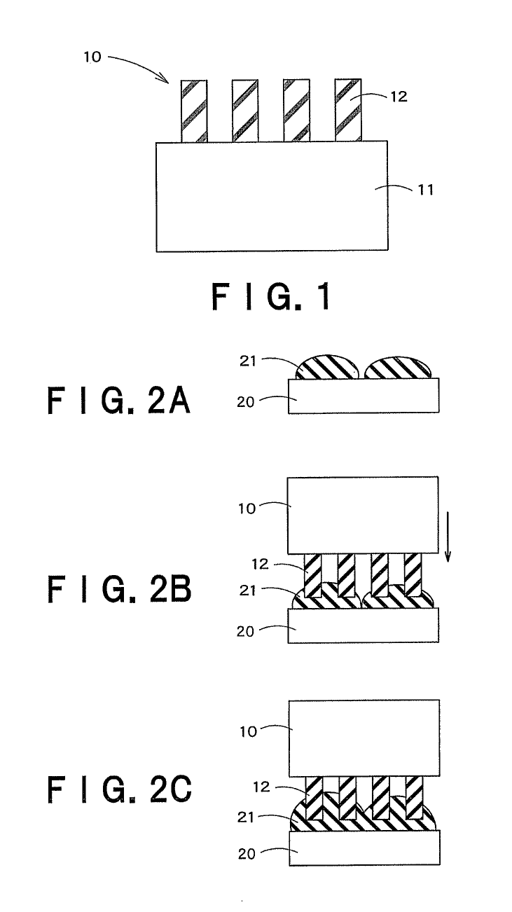

FIG. 1 is a partial vertical cross-sectional view of a template 10 according to an embodiment of the present invention. The template 10 is used for after-mentioned imprinting processing and has a concave-convex pattern on one surface thereof. As shown in FIG. 1, the template 10 includes a base material 11 and a resin layer 12 provided on the base material (base material layer) 11.

The base material 11 has light transmission characteristics and is made of, e.g., quartz glass.

The base material 11 and the resin layer 12 form a concave-convex pattern. This concave-convex pattern is formed to correspond to a pattern to be formed on a processed substrate in the after-mentioned imprinting processing.

As shown in FIG. 1, the resin layer 12 is in a convex pattern corresponding to convex portions of the concave-convex pattern of the template 10. Also, at concave portions of the concave-convex pattern of the template 10, surfaces of the base material 11 are exposed. The reason for this is that light to harden an imprinting material can reach the imprinting material sufficiently without being blocked by the resin layer 12 at the time of the imprinting processing.

The resin layer 12 has characteristics of contracting and expanding by irradiation of light. Specifically, the resin layer 12 contracts and reduces its volume by irradiation of light having a wavelength of λ1. The resin layer 12 also expands and increases its volume by irradiation of light having a wavelength of λ2, which is different from the wavelength of λ1.

The resin layer 12 is preferably made of a material excellent in adhesion to the base material 11 (quartz glass) and consists primarily of a resin material with UV curable characteristics. The resin layer 12 is formed by adding azobenzene to a commercially available UV curable resin for semiconductor, an EB curable resin, or a commercially available light curable resin for nanoimprinting. In a case where 5 wt% of azobenzene is added by weight, the resin layer 12 contracts and reduces its volume by about 10% when it is irradiated with UV light (ultraviolet light) having a wavelength of 350 nm (=λ1) for a predetermined period of time. Also, when the resin layer 12 in a contracting (volume-reduced) state is irradiated with UV light having a wavelength of 440 nm (=22) for a predetermined period of time, the resin layer 12 expands and recovers its original volume.

The concave-convex pattern of the resin layer 12 can be formed by applying a resin material to which azobenzene has been added on the base material 11 and processing this resin material by exposure and development with use of an electron beam drawing apparatus or a general semiconductor exposure apparatus or by means of a nanoimprinting method.

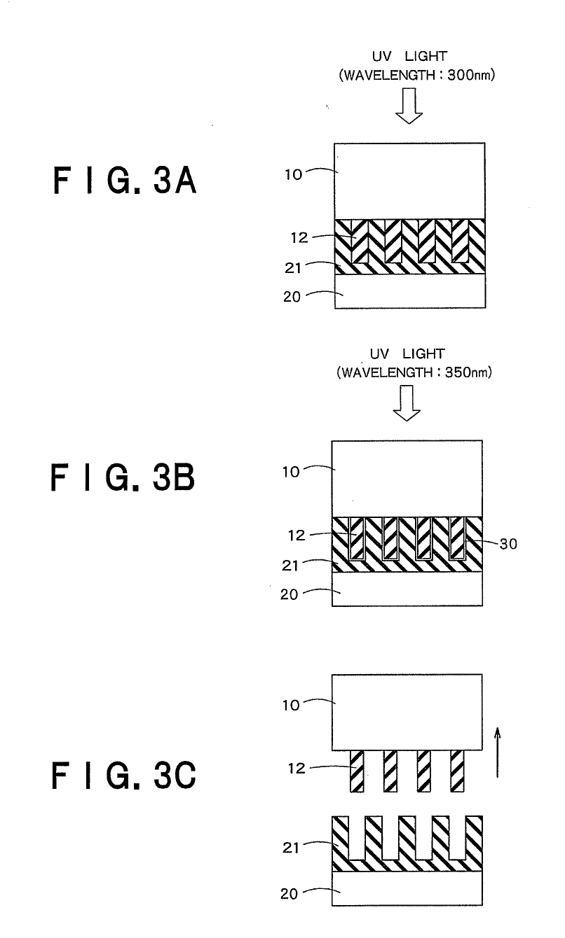

Next, imprinting processing with use of such a template 10 will be described with reference to FIGS. 2A to 2C and FIGS. 3A to 3C. It is to be noted that azobenzene shall be added to the resin layer 12 of the template 10.

As shown in FIG. 2A, an imprinting material 21 is applied on a processed substrate 20. The imprinting material 21 is a liquid light curable organic material such as acrylic monomer. It is to be noted that the wavelength of light to harden the imprinting material 21 shall be different from the wavelength of light to contract the resin layer 12. The reason for this is that, in a case where the resin layer 12 contracts when the imprinting material 21 is to be hardened, a pattern having a desired size cannot be formed on the processed substrate 20.

In this example, the imprinting material 21 is hardened with UV light having a wavelength of 300 nm.

As shown in FIG. 2B, a concave-convex pattern surface of the template 10 is brought into contact with the applied imprinting material 21. At this time, the resin layer 12 of the template 10 shall be in a normal state (non-contracting state).

As shown in FIG. 2C, the liquid imprinting material 21 flows along the concave-convex pattern of the template 10 and goes in it.

As shown in FIG. 3A, after the imprinting material 21 is filled in the concave-convex pattern, UV light having a wavelength of 300 nm is emitted from a rear surface side (upper side in the figure) of the template 10. The UV light transmits the base material 11 of the template 10 and reaches the imprinting material 21 to harden the imprinting material 21. At this time, the volume of the resin layer 12 is not changed.

After hardening of the imprinting material 21, UV light having a wavelength of 350 nm is emitted to contract the resin layer 12 (convex pattern part of the template 10), as shown in FIG. 3B. Since the imprinting material 21 is already hardened in this state, a gap 30 is formed between the imprinting material 21 and the resin layer 12 by contraction of the resin layer 12.

As shown in FIG. 3C, the template 10 is demolded from the imprinting material 21. Since there is a gap between the sidewall of the concave-convex pattern of the template 10 (resin layer 12) and the imprinting material 21, no frictional force by the sidewall of the concave-convex pattern of the template 10 is generated in the imprinting material 21. This can prevent the pattern of the imprinting material 21 from being damaged when the template 10 is to be demolded.

Subsequently, after the template 10 is demolded from the imprinting material 21, the resin layer 12 of the template 10 is irradiated with UV light having a wavelength of 440 nm to expand and recover its original volume (size). The processing of expanding the resin layer 12 may be performed at any time as long as it is before the process shown in FIG. 2B to bring the template 10 into contact with the imprinting material 21.

By repeating the processes shown in FIGS. 2A to 2C and FIGS. 3A to 3C, the imprinting material 21 having a desired concave-convex pattern can be formed on the processed substrate 20 plural times.

In this manner, by using the template 10 having the concave-convex pattern containing the resin layer 12, which contracts/expands by light having different wavelengths, the gap 30 can be provided between the template 10 and the imprinting material 21 when the template is to be demolded in the imprinting processing, which can prevent the pattern on the processed substrate from being damaged.

In the above embodiment, although the wavelength of the light to harden the imprinting material 21 is different from the wavelength of the light to contract the resin layer 12, it may further be different from the wavelength of the light to expand the resin layer 12. The reason for this is to prevent the volume of the resin layer 12 from being changed (increased) when the imprinting material 21 is to be hardened.

In the above embodiment, although the template 10 is configured to include the base material 11 and the resin layer 12, it may be configured to include only the resin layer 12 in a case where the resin layer 12 has light transmission characteristics. However, in this case, the template 10 entirely contracts/expands, which may make alignment of the template 10 difficult.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A template for imprinting having a concave-convex pattern on one surface thereof, comprising:
a base material having light transmission characteristics; and
a resin layer provided on the base material and becoming convex portions of the concave-convex pattern,
wherein the resin layer contracts and reduces its volume by irradiation of light having a first wavelength and expands and increases its volume by irradiation of light having a second wavelength, which is different from the first wavelength.

2. The template for imprinting according to claim 1, wherein, when the resin layer is irradiated with the light having the first wavelength for a predetermined period of time in a state of having a first volume, it is changed to have a second volume, which is smaller than the first volume, and when the resin layer is irradiated with the light having the second wavelength for a predetermined period of time in a state of having the second volume, its volume is changed from the second volume to the first volume.

3. The template for imprinting according to claim 1, wherein, at concave portions of the concave-convex pattern, surfaces of the base material are exposed.

4. The template for imprinting according to claim 1, wherein the resin layer contains azobenzene.

5. The template for imprinting according to claim 4, wherein the first wavelength is 350 nm while the second wavelength is 440 nm.

6. An imprinting method using a template having formed on one surface thereof a concave-convex pattern having a base material having light transmission characteristics and a convex resin layer provided on the base material and contracting and reducing its volume by irradiation of light having a first wavelength and expanding and increasing its volume by irradiation of light having a second wavelength, which is different from the first wavelength, comprising:
applying a light curable material on a processed film;
bringing the concave-convex pattern of the template into contact with the light curable material;
irradiating the light curable material with light having a third wavelength, which is different from the first wavelength, in a state of bringing the template into contact with the light curable material to harden the light curable material;
irradiating the resin layer with the light having the first wavelength after irradiation of the light having the third wavelength; and
demolding the template from the light curable material after irradiation of the light having the first wavelength.

7. The imprinting method according to claim 6, wherein the resin layer is irradiated with the light having the second wavelength before the template is brought into contact with the light curable material or after the template is demolded from the light curable material.

8. The imprinting method according to claim 6, wherein the second wavelength and the third wavelength are different.

9. The imprinting method according to claim 6, wherein the resin layer contains azobenzene.

10. The imprinting method according to claim 9, wherein the first wavelength is 350 nm while the second wavelength is 440 nm.
